(19) United States
(12) Patent Application Publication
(10) Pub. No.: US 2008/0146155 A1
(43) Pub. Date: Jun. 19, 2008

(54) METHOD AND SYSTEM FOR RELIABLE DETECTION AND AVOIDANCE OF PERIODIC INTERMITTENT INTERFERENCE

(75) Inventors: Isam R. Makhlouf, Lake Zurich, IL (US); Stephen P. Emeott, Rolling Meadows, IL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/611,718

(22) Filed: Dec. 15, 2006

(51) Int. Cl. H04B 15/00

(52) U.S. Cl. 455/63.1

(57) ABSTRACT

A method (10, 40, 50 or 55) or system (200) of detecting and avoiding periodic intermittent interference (PII) can include monitoring (12) for PII on a current channel which can include monitoring (14) by tracking retransmission statistics of isochronous traffic or by tracking channel probe request failures corresponding to temporal characteristics of microwave oven interference where PII is detected if the retransmission statistics exceed a predetermined threshold or if the probe failure requests exceed another predetermined threshold. The method can further include selecting (16) a channel or an adjacent channel with a highest level of PII when PII is detected on the current channel which can optionally include selecting (18) a preset channel known for PII interference or adaptively selecting by directly measuring energy levels on a plurality of channels. The method can switch (20) to a preferred channel when PII is no longer detected on the current channel.

### RELATED APPLICATIONS

This Application is related to Motorola Attorney Docket No. CS29870ML entitled METHOD AND SYSTEM for DETECTING PERIODIC INTERMITTENT INTERFERENCE and Motorola Attorney Docket No. CS29772ML entitled METHOD AND SYSTEM FOR PREDICTIVE SENSING OF PERIODIC INTERMITTENT INTERFERENCE, both concurrently filed herewith.

### FIELD

This invention relates wireless communications, and more particularly to a method and system for reliably detecting and avoiding intermittent interference (PII) on wireless devices.

### BACKGROUND

End users of voice over WiFi systems may experience poor audio quality or even a dropped call when using a handheld device that is unable to receive and decode voice and control packets on a noisy channel. For example, the periodic intermittent interference (PII) emitted by microwave ovens may disrupt or impair communications between an access point and a handheld device implemented according to the IEEE 802.11 standard (and operating in the 2.4 GHz band) and the access point with which it is associated to obtain network connectivity. Household microwave ovens use a magnetron tube that generally operates with about a 50% duty cycle over 16.67 ms ( 1/60 Hz) periods in North America (20 ms, 1/50 Hz in the rest of the world). In other words, the timing characteristics of the emitted energy can generally be described as a square wave, cycling on for about 8.33 ms, then off for about 8.33 ms (on/off for about 10 ms in the rest of the world). A means of avoiding on-channel interference from other devices is desired to improve the audio quality experience of the end users who own and operate voice over WiFi services.

Consider a Voice over WLAN (VoWLAN) handset using the access methods defined by IEEE 802.11. The access methods utilize a collision sensing mechanism referred to as the clear channel assessment (CCA) algorithm that senses the energy level on the channel. Since this algorithm is used to defer channel access while energy is above some threshold, the existing scheme may already seem well-suited to sensing microwave interference. Detection performance can, however, still suffer in certain scenarios. A major shortfall of this scheme is when the interference level is below the CCA threshold but still high enough to result in a low C/I, and hence lost packets, at one or both ends of the link.

For VoWLAN applications, retransmissions are usually initiated at the MAC layer, and are usually limited to 6 or so. The back-off periods between retransmissions are randomly drawn between zero and the contention window lengths that are specified for each retry in the standard. Taking into account the IEEE 802.11 Distributed Coordination Function, the cumulative back-off time is uniformly distributed between 0.238 ms and 27.5 ms for an initial delivery attempt followed by up to 6 retransmissions. So if a microwave oven is not detected (by the CCA algorithm), and an initial packet delivery attempt occurs during the magnetron tube's on-cycle, all retransmission attempts can occur (and fail) before the on-cycle ends.

One patent proposes increasing the WLAN data rate in the presence of intermittent interference in order to reduce the packet length and hence the probability of collision with the interference. This method does not seek to avoid the interference. In addition, the higher data rates have less range. Other patent publications propose avoiding transmitting on those frequencies/channels where intermittent interference is detected, and/or scheduling transmissions around it. Many microwave ovens emit interference across the entire ISM band, so there may be no clear frequencies or channels. As for scheduling transmissions around detected interference, certain microwave ovens have poorly defined emission characteristics vs. time, so the cycle timing may not always be reliably detectable.

### SUMMARY

Embodiments in accordance with the present invention can provide a reliable method and system for detecting and avoiding periodic intermittent interference (PII) in a manner that is likely considered counterintuitive since embodiments include selecting a channel or an adjacent channel with the highest level of PII.

In a first embodiment of the present invention, a method of channel selection in the presence of periodic intermittent interference (PII) can include the steps of monitoring for PII on a current channel and selecting a channel or an adjacent channel with a highest level of PII when PII is detected on the current channel. The step of selecting the channel or adjacent channel with the highest level of PII can be done by selecting a preset channel known for PII interference or by directly measuring energy levels on a plurality of channels. The method can further include the step of switching to a preferred or clearer channel when PII is no longer detected on the current channel. The method can further include the step of sending a channel switch request to an access point or to a handset in communication with the access point. The method can further include the step of receiving a channel switch request from a handset or from an access point in communication with the handset. The method can further include the step of a handset sending a channel switch request message to a serving access point when PII is detected and where the message comprises a channel switch request to a channel close in center frequency to the PII, a PII detection indicator signal or interference statistics or measurements. The step of monitoring can include tracking retransmission statistics of isochronous traffic or tracking channel probe request failures corresponding to temporal characteristics of microwave oven interference and wherein PII is detected if the retransmission statistics exceed a predetermined threshold or if the probe failure requests exceed another predetermined threshold.

In a second embodiment of the present invention, a system of channel selection in the presence of periodic intermittent interference (PII) can include a transceiver and a processor coupled to the transceiver. The processor can be programmed to monitor for PII on a current channel and select a channel or an adjacent channel with a highest level of PII when PII is detected on the current channel. The processor can be programmed to monitor by tracking retransmission statistics of isochronous traffic or by tracking channel probe request failures corresponding to temporal characteristics of microwave oven interference and wherein PII is detected if the retransmission statistics exceed a predetermined threshold or if the probe failure requests exceed another predetermined threshold. The processor can be further programmed to switch to a preferred or clearer channel when PII is no longer detected on the current channel. The processor can also be programmed to select the channel or adjacent channel with the highest level of PII by selecting a preset channel known for PII interference. The processor can also be programmed to select the channel or adjacent channel with the highest level of PII adaptively by directly measuring energy levels on a plurality of channels. The processor can further be programmed to send a channel switch request to an access point or to a handset in communication with the access point or alternatively receive a channel switch request from a handset or from an access point in communication with the handset. The processor can alternatively be programmed to send a channel switch request message to a serving access point when PII is detected and wherein the message comprises a channel switch request to a channel close in center frequency to the PII, a PII detection indicator signal or interference statistics or measurements. The system can be an access point or a portable mobile station in a WLAN or WiMAX or WiFi communication system.

In a third embodiment of the present invention, a portable communication device having a system of channel selection in the presence of periodic intermittent interference (PII) can include a transceiver, a PII detector coupled to the transceiver, and a processor coupled to the transceiver and the PII detector. The processor can be programmed to monitor for PII on a current channel and select a channel with a highest level of PII when PII is detected on the current channel. The processor can further be programmed to send a channel switch request message to a serving access point when PII is detected and wherein the message comprises a channel switch request to a channel close in center frequency to the PII, a PII detection indicator signal or interference statistics or measurements.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a midlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart of a method of detecting and avoiding PII in accordance with an embodiment of the present invention.

FIG. 2 is a block diagram illustrating a communication system subjected to PII in accordance with an embodiment of the present invention.

FIG. 3 is a flow chart illustrating another method of detecting and avoiding PII in accordance with an embodiment of the present invention.

FIG. 4 is a flow chart illustrating yet another method of detecting and avoiding PII in accordance with an embodiment of the present invention.

FIG. 5 is a flow chart illustrating yet another method of detecting and avoiding PII in accordance with an embodiment of the present invention.

FIG. 6 is an illustration of a system for detecting and avoiding PII in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

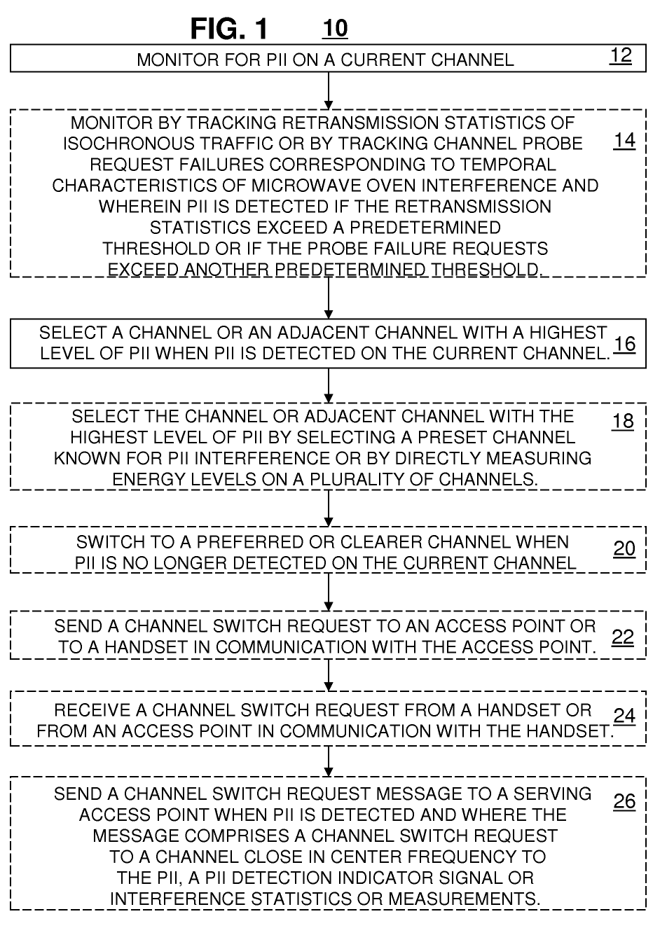

Referring to FIG. 1, a flow chart illustrating a method 10 of channel selection in the presence of periodic intermittent interference (PII) can include the step 12 of monitoring for PII on a current channel which can include at optional step 14 monitoring by tracking retransmission statistics of isochronous traffic or by tracking channel probe request failures corresponding to temporal characteristics of microwave oven interference and wherein PII is detected if the retransmission statistics exceed a predetermined threshold or if the probe failure requests exceed another predetermined threshold. The method can further include the step 16 of selecting a channel or an adjacent channel with a highest level of PII when PII is detected on the current channel which can optionally include the steps 18 of selecting a preset channel known for PII interference or adaptively selecting by directly measuring energy levels on a plurality of channels. The method can switch to a preferred or clearer channel when PII is no longer detected on the current channel at step 20. The method at step 22 can send a channel switch request to an access point or to a handset in communication with the access point or at step 24 can receive a channel switch request from a handset or from an access point in communication with the handset. The method can alternatively send a channel switch request message to a serving access point at step 26 when PII is detected and where the message comprises a channel switch request to a channel close in center frequency to the PII, a PII detection indicator signal or interference statistics or measurements.

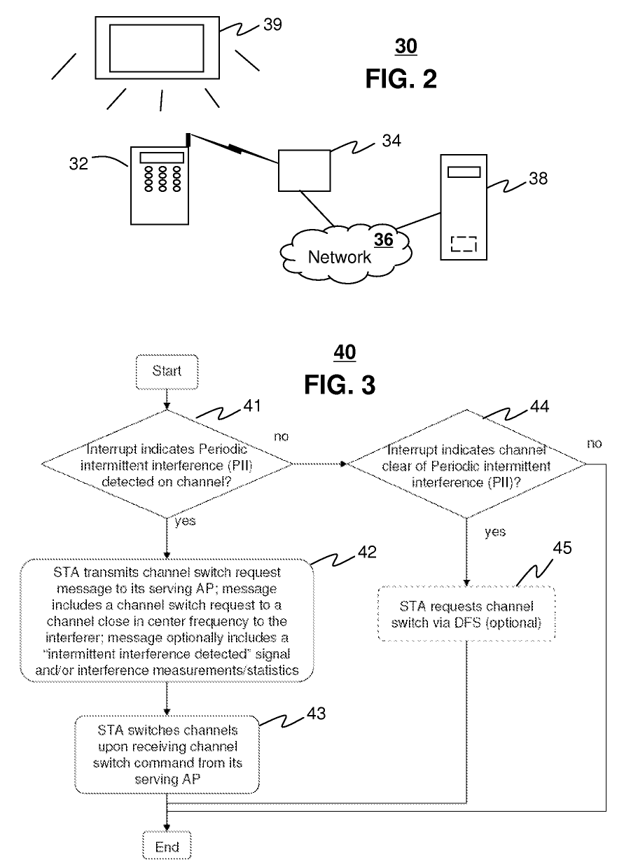

With reference to FIG. 2, a simple communication system 30 subjected to PII is illustrated. The system 30 can include a Wifi or WLAN or WiMAX radio transceiver unit or communication handset 32 operatively coupled to an access point (AP) 34. The access point 34 can be coupled to computer or server 38 via a communication network 36. The PII source 39 can be any number of device, but in most instances will likely be a microwave oven.

The embodiments herein provide a channel selection scheme to improve performance in the presence of periodic intermittent interference (PII). The scheme can select a channel with the highest level of PII, or one adjacent to it, when PII is detected on a current channel. The channel with the most PII energy can be determined through indirect means or through direct measurement of the interference power, or can be assumed based on the operating frequencies of typical PII generating devices (e.g., 2.45 GHz for microwave ovens). This approach maximizes the likelihood that the existing channel-sensing implementations (e.g., CCA) at both ends of the link are effective at detecting PII, especially when the interference source is far from one end of the link and/or of relatively low power. When the interference is no longer detected, a switch to a preferred and/or clearer channel can optionally occur.

Referring to FIG. 3, a method 40 at a mobile communication device or station of detecting and selecting a channel can include the step of determining if PII is on a current channel at decision block 41. If PII is indicated, the mobile communication device can transmit at step 42 a channel switch request message to its serving access point (AP). Such a switch request message can optionally include a channel switch request to a channel close in center frequency to the PII source or interferer or a “PII detected” signal or interference measurements or statistics. At step 43, the mobile communication device can switch channels upon receiving a channel switch command from its serving AP. If no PII is indicated at decision block 41, then the method can further determine if a clear channel indication is provided at decision block 44. If no clear channel is indicated the method just ends. If a clear channel is indicated at decision block 44, then the mobile communication device can optionally request a channel switch (via DFS or by other means under the IEEE 802.11 standard or otherwise).

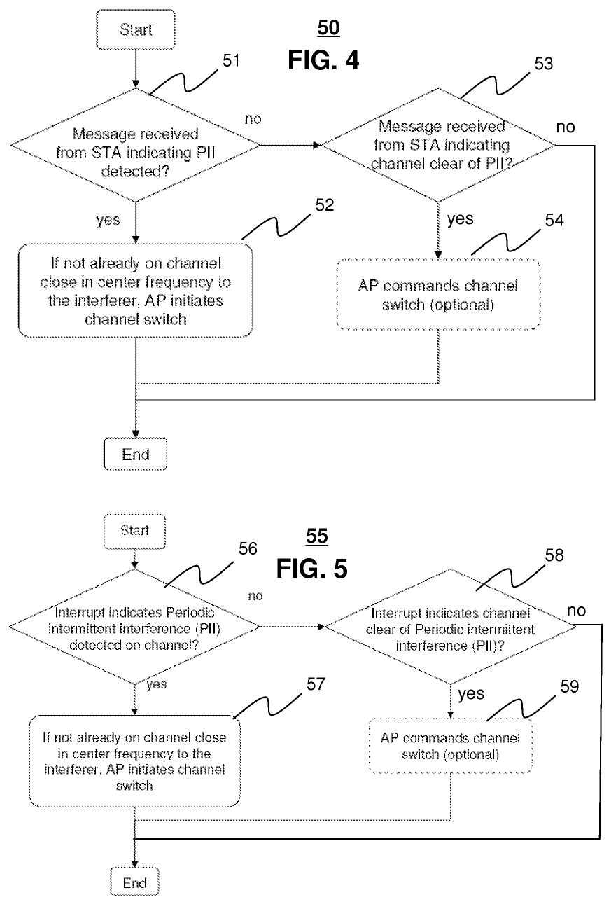

Referring to FIG. 4, a method 50 of detecting and selecting a channel at an access point (AP) is shown where the mobile wireless communication device in communication with the AP includes a PII detector. The method 50 can include the step of determining if a message is received from the mobile wireless device indicating detection of PII at decision block 51. If PII is indicated at decision block 51, then the AP initiates a channel switch at step 52 if the current channel is not already on a channel close in center frequency to the PII source or interferer. If no message is received indicating detection of PII is received at decision block 51, then a determination is made whether a message is received from the mobile wireless device indicating a channel clear of PII at decision block 53. If the clear channel message is received at decision block 53, then the method can have the AP optionally command a channel switch at step 54. If no clear channel is indicated the method just ends.

Referring to FIG. 5, a method 55 of detecting and selecting a channel at an access point (AP) is shown where the AP includes a PII detector. The method 55 can include the step of determining if PII is indicated at decision block 56. If PII is indicated at decision block 56, then the AP initiates a channel switch at step 57 if the current channel is not already on a channel close in center frequency to the PII source or interferer. If no detection of PII is indicated at decision block 56, then a determination is made whether a channel clear of PII is indicated at decision block 58. If the clear channel is indicated at decision block 58, then the method can have the AP optionally command a channel switch at step 59. If no clear channel is indicated the method just ends.

The embodiments herein can be implemented in the AP, handset, or both, independent of where the PII detector resides. In one embodiment, the selection scheme and PII detector are both implemented in the handset. In this case, channel switch requests can be made by the handset, possibly through the use of extensions to the 802.11h channel switch mechanisms for example. In an alternate embodiment where the selection scheme is implemented in the AP and the PII detection is implemented in the handset, the PII detection can be related to the AP as an 802.11k type of measurement (i.e. “RF channel knowledge”), for example.

The embodiments herein proposes novel and counterintuitive schemes (in that channels selected are channels with the greatest interference energy) to maximize the ability of devices at both ends of the link to detect the presence of PII. In doing so, the embodiments herein enable a system to take advantage of long (relative to voice packet lengths) “quiet” periods in some types of PII, like that produced by microwave ovens. The embodiments herein do not try to avoid the interference through frequency selection, a technique proposed in the existing art that, as explained above, that may not work effectively with certain microwave ovens that emit relatively high power levels across the entire ISM band. The embodiments herein also do not necessarily rely on interference waveform or onset timing identification, which is a complex, power-draining, and potentially unreliable approach (especially with certain ovens and/or certain topologies, as when the interference source is far from one end of the link) also proposed in some of the existing art. Instead, the embodiments herein can just use the detection (directly or indirectly) of periodic intermittent interference, not necessarily its timing characteristics. The embodiments can be implements on Wifi, WLAN, or WiMAX handset or dual mode cellular/WiFi (or WLAN or WiMAX) handsets, and generally can be used in any voice over WiFi/WLAN/WiMAX system.

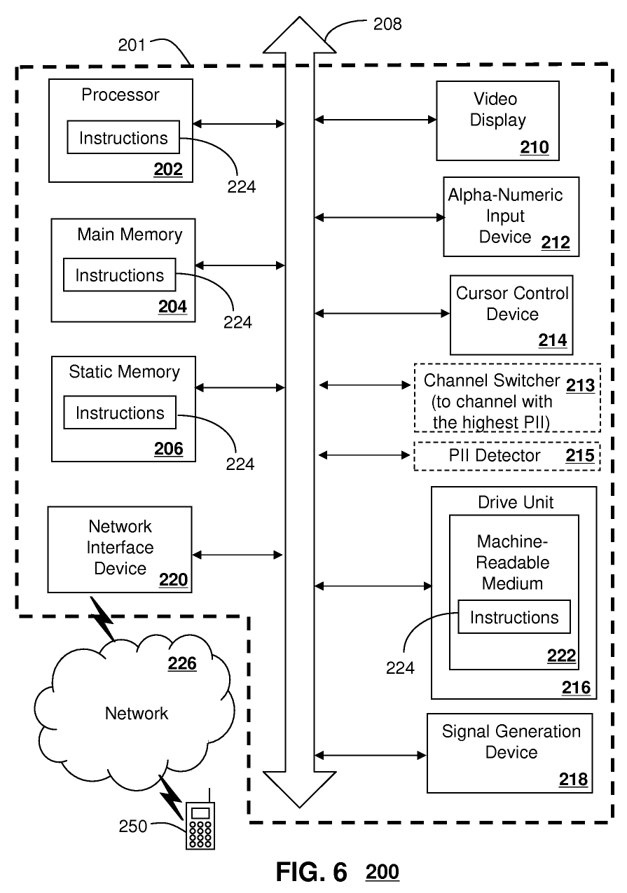

FIG. 6 depicts an exemplary diagrammatic representation of a machine in the form of a computer system 200 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such as a video display unit 210 (e.g., a liquid crystal display (LCD), a flat panel, a solid state display, or a cathode ray tube (CRT)). The computer system 200 may include an input device 212 (e.g., a keyboard), a cursor control device 214 (e.g., a mouse), a disk drive unit 216, a signal generation device 218 (e.g., a speaker or remote control that can also serve as a presentation device) and a network interface device 220. The embodiments can also optionally include a module 213 for switching to the channel (or adjacent channel) with the highest PII and a PII detector 215 (such as indirect or inferred detector or a direct detector) which can be in hardware or software or any combination thereof. These functions can alternatively be done within the contemplated embodiments in the processor 202 which can be a DSP. Of course, in the embodiments disclosed, many of the functions described above can be optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor 202 during execution thereof by the computer system 200. The main memory 204 and the processor 202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein. Further note, the embodiments are not necessarily limited to song files, but can also include video files or multimedia files that can have a pace or tempo associated with such files.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of channel selection in the presence of periodic intermittent interference (PII), comprising the steps of:
monitoring for PII on a current channel; and
selecting a channel or an adjacent channel with a highest level of PII when PII is detected on the current channel.

2. The method of claim 1, wherein the method further comprises the step of switching to a preferred or clearer channel when PII is no longer detected on the current channel.

3. The method of claim 1, wherein the step of selecting the channel or adjacent channel with the highest level of PII is done by selecting a preset channel known for PII interference.

4. The method of claim 1, wherein the step of selecting the channel or adjacent channel with the highest level of PII is done adaptively by directly measuring energy levels on a plurality of channels.

5. The method of claim 1, wherein the method further comprises the step of sending a channel switch request to an access point or to a handset in communication with the access point.

6. The method of claim 1, wherein the method further comprises the step of receiving a channel switch request from a handset or from an access point in communication with the handset.

7. The method of claim 1, wherein a handset sends a channel switch request message to a serving access point when PII is detected and wherein the message comprises a channel switch request to a channel close in center frequency to the PII, a PII detection indicator signal or interference statistics or measurements.

8. The method of claim 1, wherein the step of monitoring comprises tracking retransmission statistics of isochronous traffic or tracking channel probe request failures corresponding to temporal characteristics of microwave oven interference and wherein PII is detected if the retransmission statistics exceed a predetermined threshold or if the probe failure requests exceed another predetermined threshold.

9. A system of channel selection in the presence of periodic intermittent interference (PII), comprising:
a transceiver; and
a processor coupled to the transceiver, wherein the processor is programmed to:
monitor for PII on a current channel; and
select a channel or an adjacent channel with a highest level of PII when PII is detected on the current channel.

10. The system of claim 9, wherein the processor is further programmed to switch to a preferred or clearer channel when PII is no longer detected on the current channel.

11. The system of claim 9, wherein the processor is programmed to select the channel or adjacent channel with the highest level of PII by selecting a preset channel known for PII interference.

12. The system of claim 9, wherein the processor is programmed to select the channel or adjacent channel with the highest level of PII adaptively by directly measuring energy levels on a plurality of channels.

13. The system of claim 9, wherein the processor is further programmed to send a channel switch request to an access point or to a handset in communication with the access point.

14. The system of claim 9, wherein the processor is further programmed to receive a channel switch request from a handset or from an access point in communication with the handset.

15. The system of claim 9, wherein the processor is further programmed to send a channel switch request message to a serving access point when PII is detected and wherein the message comprises a channel switch request to a channel close in center frequency to the PII, a PII detection indicator signal or interference statistics or measurements.

16. The system of claim 9, wherein the processor monitors by tracking retransmission statistics of isochronous traffic or by tracking channel probe request failures corresponding to temporal characteristics of microwave oven interference and wherein PII is detected if the retransmission statistics exceed a predetermined threshold or if the probe failure requests exceed another predetermined threshold.

17. The system of claim 9, wherein the system is an access point in a WLAN or WiMAX or WiFi communication system.

18. The system of claim 9, wherein the system is a portable mobile station in a WLAN or WiMAX or WiFi communication system.

19. A portable communication device having a system of channel selection in the presence of periodic intermittent interference (PII), comprising:
a transceiver;
a PII detector coupled to the transceiver; and
a processor coupled to the transceiver and the PII detector, wherein the processor is programmed to:
monitor for PII on a current channel; and
select a channel with a highest level of PII when PII is detected on the current channel.

20. The portable communication device of claim 19, wherein the processor is further programmed to send a channel switch request message to a serving access point when PII is detected and wherein the message comprises a channel switch request to a channel close in center frequency to the PII, a PII detection indicator signal or interference statistics or measurements.
